(19) United States
(12) Patent Application Publication
(10) Pub. No.: US 2012/0253923 A1
(43) Pub. Date: Oct. 4, 2012

(54) SYSTEMS AND METHODS FOR PROVIDING TARGETED MARKETING CAMPAIGN TO MERCHANT

(75) Inventors: Sastry VSM Durvasula, Phoenix, AZ (US); Sangeeta Ramesh Naik, Hoboken, NJ (US); Sherree Rae Newhouse, Phoenix, AZ (US); Kathleen Evelyn Senior, Holly Springs, NC (US); Sripriya V. Tiku, Scottsdale, AZ (US)

(73) Assignee: American Express Travel Related Services Company, Inc., New York, NY (US)

(21) Appl. No.: 13/073,557

(22) Filed: Mar. 28, 2011

(51) Int. Cl. G06Q 30/00

(52) U.S. Cl. 705/14.43; 705/14.53

(57) ABSTRACT

Methods, systems and computer readable medium are provided for providing targeted marketing services. Historical transaction data is analyzed by a computer based system to provide an aggregate data profile of transaction account holders which participated in transactions with a first entity. A targeted marketing campaign is selected by the computer based system from a selection of available targeted marketing campaigns to propose to the first entity based on the aggregate data profile of transaction account holders. The selected targeted marketing campaign is then proposed by the computer based system to the first entity.

### BACKGROUND OF THE INVENTION

1. Field of Invention

The present disclosure generally relates to providing a targeted marketing campaign, and more particularly, to providing a targeted marketing campaign to a merchant based on historical transaction data of customers.

2. Related Art

Merchants generally aim to increase their customer base in order to increase their business and to compete with other merchants, which may be in a similar business domain. In order to increase the customer base, marketing campaigns are generally run by the merchants for reaching potential customers. The marketing campaigns could be an online marketing campaign or an offline marketing campaign targeted to reach the potential customers.

Typically, marketing campaigns employ predictive analytics and models to identify potential customers, most likely to respond to a particular marketing offer provided by the merchants. For example, such marketing campaigns may be designed considering survey information related to a merchant and customer relation with regard to a particular product or service over a period of time.

However, this type of marketing campaign may not reach the potential customers, as the survey information is based mainly on the predictive analytics, and customers may not likely behave according to the predictive analytics. The deviation in the marketing campaign may lead to wasted resources and may consequently impact a merchant's business. Accordingly, present methodologies for designing marketing campaigns for the merchants may not be efficient enough to target/reach potential consumers.

Given the foregoing, what is needed is to provide an efficient targeted marketing campaign to a merchant.

### SUMMARY OF THE INVENTION

The present disclosure meets the above-identified need by providing methods, systems and non-transitory computer-readable medium for providing targeted marketing campaigns.

In one exemplary method, historical transaction data is analyzed by a computer based system to provide an aggregate data profile of transaction account holders whom have participated in transactions with a first entity. A targeted marketing campaign is selected from a selection of available targeted marketing campaigns to propose to the first entity based on the aggregate data profile of transaction account holders. The selected targeted marketing campaign is then proposed by the computer based system to the first entity. The method may include receiving available targeted marketing campaign information from campaign marketing providers.

In an exemplary embodiment, the aggregate data profile of transaction account holders may include a comparison of transaction account holders participating in transactions with a second entity and transaction account holders participating in transactions with the first entity. The aggregate data profile of transaction account holders may include a holistic data comparison among of the transaction account holders participating in transactions with the first entity and/or comparisons of characteristic data among transaction account holders participating in transactions with the first entity. The characteristic data may include age information, gender information, tenure information, martial status information, domicile information, family related information, social networking data, survey data, purchasing power information, size of wallet information, travel related information, hobby information, employer information, employment information, vocational information, education information, ethnicity information, government data, merchant rewards system data, third-party data, geographic information data, census bureau data, affinity group information, and/or income information.

In various embodiments, selecting the targeted marketing campaign is limited by a selection of a factor such as time and cost. The targeted marketing campaign may include direct mail, email, twitter, social networking portals, specific discount offers, cross-marketing, cross-promotional materials, telemarketing, and/or in person offers.

In various embodiments, the targeted marketing campaign is provided by a third party. This third party may have a business relationship with the operator of the computer based system. The first entity may be enrolled to use the system. The computer based system may be configured to provide the targeted marketing campaign services to the entity upon receipt of agreement by the first entity. The computer based system may be configured to track the redemption of targeted marketing campaign services by transaction account cardholders. Also, the computer based system may be configured to track quality of the targeted marketing campaign services produced and/or periodically adjust the selection of available targeted marketing campaigns in response to the tracked quality.

In some embodiments, the aggregate data profile of transaction account holders which participated in transactions with the first entity may be based on actual historical data and not based on survey data. The first entity may be a small business. The aggregate data profile may be provided by the computer based system to the first entity.

In various embodiments, the targeted marketing campaign may include matching contact information of transaction account holders to targeted marketing campaign services. The transaction account holders targeted for marketing may include those that have participated in transactions with a first entity and/or those that are determined, by the computer based system, to be likely to participate in transactions with a first entity in the future.

Further features and advantages of the present disclosure as well as the structure and operation of various embodiments are described in detail below with reference to the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an exemplary embodiment of an environment in which a targeted marketing module for providing a targeted marketing campaign may be deployed;

FIG. 2 is an exemplary implementation of the targeted marketing module for providing a targeted marketing module to a merchant, according to an embodiment;

FIG. 3 is an account information page of an exemplary online interface of the targeted marketing module, according to an embodiment;

FIG. 4 is an enrollment/registration page of an exemplary online interface of the targeted marketing module, according to an embodiment;

FIG. 5 is a request customer analysis page of an exemplary online interface of the targeted marketing module, according to an embodiment;

FIG. 6 is a terms and conditions page of an exemplary online interface of the targeted marketing module, according to an embodiment;

FIG. 7 is an interaction page between third party service providers and the merchant, according to an embodiment;

FIG. 8 is another interaction page between the third party service providers and the merchant, according to an embodiment;

FIG. 9 is a flowchart illustrating one example process for providing targeted marketing campaign to a first entity, according to an embodiment; and

FIG. 10 is a block diagram of an exemplary computer system, according to an embodiment.

### DETAILED DESCRIPTION OF THE INVENTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to system architecture, block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like. The merchant may be a small, medium or large sized business entity. The merchant may use this system and method to find specific information about their business.

A “consumer”, as used herein, may include any individual, business, entity, group, charity, software and/or hardware that have a transaction account. The transaction account may be associated with an issuer. It is noted that the terms “customer,” “consumer,” “transaction account holders”, “user” and “population” are used interchangeably herein.

A “transaction account” as used herein refers to an account associated with an open account or a closed account system (as described below). The transaction account may exist in a physical or non-physical embodiment. For example, a transaction account may be distributed in non-physical embodiments such as an account number or code, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments are embodied in a systems and methods for selecting and proposing a targeted marketing campaign for the merchant. The nomenclature “marketing campaign” is only exemplary and used for descriptive purposes, and must not be construed to limit the scope of the present disclosure.

The present disclosure is now described in more detail herein in terms of the above disclosed exemplary embodiments of system, processes and computer program products. This is for convenience only and is not intended to limit the application of the present disclosure. In fact, after reading the following description, it will be apparent to one skilled in the relevant art(s) how to implement the following disclosure in alternative embodiments.

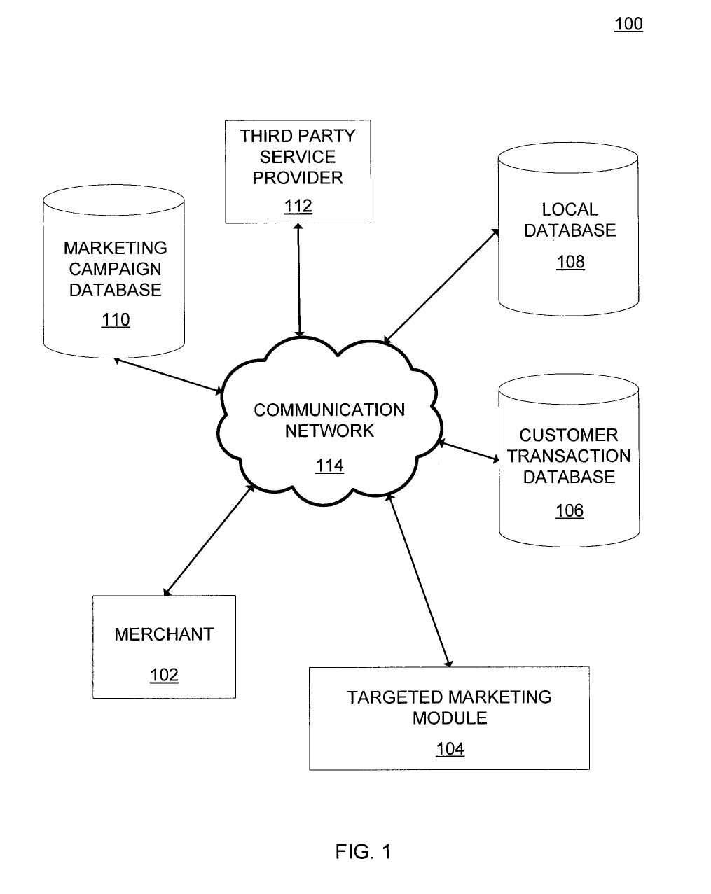

FIG. 1 depicts an exemplary environment 100 in which the present disclosure may be utilized, in accordance with an embodiment. Environment 100 may include at least one merchant, such as a merchant 102 (hereinafter interchangeably referred to as a first entity 102), a targeted marketing module 104, a customer transaction database 106, local database 108, marketing database 110, third party service provider 112, and a communication' network 114. Merchant 102, targeted marketing module 104, customer transaction database 106, local database 108, marketing database 110 and third party service provider 112 communicate with each other over communication network 114. Examples of communication network 114 may include, but is not limited to, a wide area network (WAN), a local area network (LAN), an Ethernet, Internet, an Intranet, a cellular network, a satellite network, or any other suitable network for transmitting data. Communication network 114 may be implemented as a wired network, a wireless network or a combination thereof

Merchant 102 may include any hardware and/or software suitably configured to facilitate input, receipt and/or review of information relating to a marketing campaign or any information discussed herein. As those skilled in the art will appreciate, merchant 102 may include an operating system (e.g., Windows NT, 95/98/2000, OS2, UNIX, Linux, Solaris, MacOS, etc.) as well as various conventional support software and drivers typically associated with computers. Further, merchant 102 may include any suitable personal computer, network computer, workstation, minicomputer, mainframe or the like. Furthermore, merchant 102 may be in a home or business environment with access to a network. In an exemplary embodiment, access is through a network or the Internet through a commercially available web-browser software package.

In an exemplary implementation as shown in FIG. 1, targeted marketing module 104 may be communicatively coupled with merchant 102 through communication network 114. Further, customer transaction database 106, local database 108, marketing database 110 and third party service provider 112 may be communicably coupled with targeted marketing module 104 via communication network 114 discussed herein. Customer transaction database 106, local database 108 and marketing database 110 may include any device (e.g., personal computer). These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that customer transaction database 106, local database 108, marketing database 110, and third party service provider 112 may or may not be in direct contact with targeted marketing module 104. For example, targeted marketing module 104 may access the services of customer transaction database 106, local database 108, marketing database 110, and third party service provider 112 through another server, which may have a direct or indirect connection with communication network 114.

Targeted marketing module 104 may be deployed as a separate entity on a third party server. In another embodiment, targeted marketing module 104 may be deployed on one or more servers associated with merchant 102. Although, targeted marketing module 104 is described herein in terms of providing marketing campaign, it will be readily apparent to one skilled in the art that a similar targeted marketing module may be deployed for other types of products/services such as, but without limitation, offering financial transaction instruments, open transaction instruments, loans, insurance plans, travel packages, retail goods and the like.

Targeted marketing module 104 may be configured to select and propose marketing campaign for merchant 102. Specifically, targeted marketing module 104 may analyze historical transaction data to establish an aggregate data profile of the transaction account holders (customers) that have participated in transactions with merchant 102. In an embodiment, targeted marketing module 104 may also analyze historical transaction data of the customers that are likely to participate in transactions with merchant 102 in the future. The historical transaction data of the customers may be received from customer transaction database 106, which is explained further in detail. In the present embodiment, targeted marketing module 104 may utilize other characteristic data of the customers apart from the historical transaction data to establish the aggregate data profile of the customers. Other characteristic data of the customers may be received from local database 108. Targeted marketing module 104 may select the appropriate marketing campaign for merchant 102 from marketing campaign database 110.

Targeted marketing module 104 may utilize services of third party service provider 112 to propose a marketing campaign to merchant 102. Targeted marketing module 104 may be configured to share at least a portion of the aggregate data profile of customers with the third party service provider 112 through communication network 114. Third party service provider 112 may design/propose a customized marketing campaign for merchant 102 based on the aggregate data profile of the customers. Third party service provider 112 may include, but is not limited to, marketing agencies, advertising agencies, campaign service providers, and the like. Third party service provider 112 may be adapted to design and perform an online and/or an offline marketing campaign or advertising campaign. In one embodiment, third party service provider 112 may have a business relationship with an operator of targeted marketing module 104. The business relationship may include financial contract between the operator and/or third party service provider 112.

Customers or transaction account holders may use a transaction account to communicate with merchant 102 in person (e.g., at the box office), telephonically, or electronically (e.g., from a user computer via the Internet). During the interaction, merchant 102 may offer goods and/or services to the customers. Merchant 102 may also offer the customer the option of paying for the goods and/or services using any number of available transaction accounts. Furthermore, the transaction accounts may be used by the merchant 102 as a form of identification of the customers. Merchant 102 may have a computing unit implemented in the form of a computer-server, although other implementations are possible. In general, transaction accounts may be used for transactions between the customer and merchant 102 through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like. The transaction accounts may be associated with loyalty programs to encourage use of the transaction accounts by a transaction account holder.

Customer transaction database 106 may store consumer's transaction history. The transaction history may include transaction value, transaction date, transaction time, transaction address, and/or frequency of transaction performed by customers. It may be evident to those skilled in the art that the above customer's transaction history is the transaction history of the customers who have participated in transactions with merchant 102. Further, customer transaction database 106 may also store customer's transaction history associated with other merchants (second entity), which may be a competitor to merchant 102 (first entity). Accordingly, while establishing the aggregate data profile of the customers, the transaction history associated with competitor merchants (second entity) may also be taken in consideration.

Local database 108 may store other characteristic data of the customers, apart from the transaction history. It may be evident to those skilled in the art that local database 108 may include a plurality of databases, storing a particular characteristic data or a group of characteristic data associated with the customers. For example, local database 108 may store back account related data such as account transactions, opening balance, closing balance, average balance over a period of time, interest earned over a period of time, etc. Further, local database 108 may include consumer's personal information including a name, an address, current geographical location, gender, age, martial status information, education information, income information and other demographic information, contact details, such as e-mail address, phone number, correspondence address, social security number, and the like. Moreover, local database 108 may store tenure information, domicile information, family related information, social networking data, survey data, purchasing power information, size of wallet information, travel related information, hobby information, employer information, employment information, vocational information, ethnicity information, government data, merchant rewards system data, third-party data, census bureau data, affinity group information.

Further, local database 108 may store customers' lifestyle related data. E.g. whether the customer frequently travels by air or whether customer spends a significant amount of money shopping or whether the customer's account reflects a significant amount of transaction at gas stations, etc. This lifestyle related data provides information relating to customer's spending trends. Consequently, providing information about customer's interest for a particular type of service or product.

Local database 108 may also store customers' behavior related data. The customer's behavior information includes Internet Protocol (IP) address, unique cookie identification data, web browsing patterns, online purchase history etc. In various embodiments, the customer's personal information may be entered by the customer for instance, while creating a profile on a merchant's 102 website. Further, the customers may also provide their preference setting, related to the offers that they might receive from the merchant 102, on merchant's 102 website. In one implementation, local database 108 obtains the customers' behavior related data through third party sources. In an embodiment, third party sources may include various online service providers, for example, Google Analytics, Urchin Software from Google Inc., Yahoo Web Analytics, Omniture's Site Catalyst and the like.

Local database 108 may also include database of a bank, a database of another merchant, a database of an airlines, a database of a chain of retail stores and the like. For example, local database 108 may extract data relating to income range, investment portfolio, spending patterns, household income, and credit history of customers. Local database 108 may also retrieve information from a database of social networking websites. This information may be related to activity of customers on the networking website.

Marketing campaign databases 110 may store various marketing campaigns either populated by the operator of targeted marketing module 104 or by third party service provider 112.

Customer transaction database 106, local database 108, and marketing campaign databases 110 may employ any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. Any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of customer transaction database 106, local database 108, and marketing campaign databases 110, data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant 102, issuer (operator of targeted marketing module 104), customers or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. Customer transaction database 106, local database 108, and marketing campaign databases 110 contemplate a data storage arrangement wherein the header or trailer, or header or trailer history, of the data is stored on the transaction instrument in relation to the appropriate data. One skilled in the art will also appreciate that, for security reasons, any databases, systems, devices, servers or other components of customer transaction database 106, local database 108, and marketing campaign databases 110 may consist of any combination thereof at a single location or at multiple locations, wherein each database or system includes any of various suitable security features, such as firewalls, access codes, encryption, decryption, compression, decompression, and/or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

The system may be implemented as article of manufacture including a non-transitory, tangible computer readable medium having instructions stored thereon that, in response to execution by a computer-based system, cause the computer-based system to perform operations.

The disclosure may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory, such as a non-transitory, tangible computer readable medium having instructions stored thereon that, in response to execution by a computer-based system that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

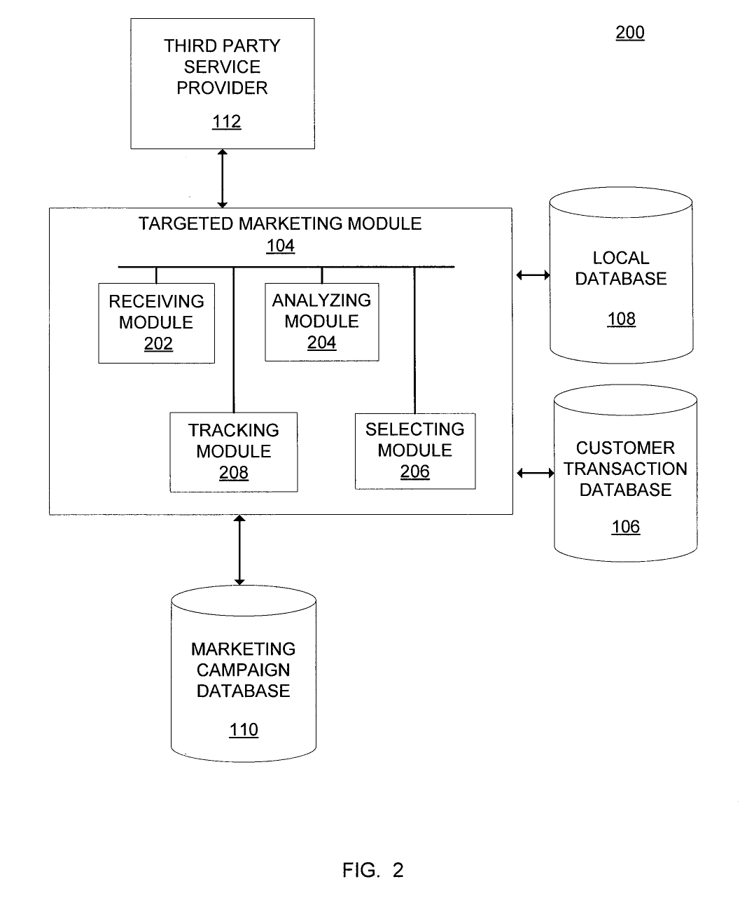

Referring to FIG. 2, an exemplary implementation of targeted marketing module 104 is depicted, according to an embodiment. As shown in FIG. 2, in an exemplary embodiment, targeted marketing module 104 may include a receiving module 202, an analyzing module 204, a selecting module 206, and a tracking module 208.

As shown in the exemplary embodiment of FIG. 2, targeted marketing module 104 may be configured to communicate with customer transaction database 106, local database 108, marketing campaign databases 110, and third party service provider 112 through communication network 114. In an embodiment, targeted marketing module 104 may be an online interface that may be offered to merchant 102 to find specific information about the merchant's 102 business. The information may include, transactional information of the customers who are or have participated in transactions with merchant 102, and/or transactional information of the customers who are or have participated in transactions with competitors of merchant 102. For instance, the system may utilize historical transaction data acquired in the normal course of business prior to the merchant 102 requesting targeted marketing campaigns.

Further, targeted marketing module 104 may provide a marketing campaign to merchant 102 based on the historical transaction data of the customers who are participating in transaction with merchant 102. Specifically, targeted marketing module 104 may analyze historical transaction data of the customers to establish an aggregate data profile of the customers participated in transaction with merchant 102. Targeted marketing module 104 may also analyze other characteristic data of the customers to establish the aggregate data profile of the customers. Thereafter, targeted marketing module 104 may select and propose a targeted marketing campaign to merchant 102.

Receiving module 202 of targeted marketing module 104 may receive a request from merchant 102 to perform a customer analysis. The request may also include providing a targeted marketing campaign to merchant 102 based on the customer's analysis.

Merchant 102 may be an enrolled member of targeted marketing module 104. Alternatively, targeted marketing module 104 may request merchant 102 to enroll/register with targeted marketing module 104. Merchant 102 may generate a user name and password for login in targeted marketing module 104 to enroll with targeted marketing module 104. Further, merchant 102 may provide information such as contact information, and/or business information. In response to the merchant 102 enrolling/registering with the targeted marketing module 104, merchant 102 may request the customer analysis from targeted marketing module 104.

Receiving module 202 may further request merchant 102 to provide information to perform the customer's analysis. The one or more information may include the business name and addresses, business type, industry, and/or average transaction size. In an embodiment, targeted marketing module 104 may provide an interface to merchant 102 to select the location, input business name, addresses and industry type, select business type, average transaction type and the like. In an embodiment, merchant 102 may select to skip the step of providing the above mentioned information, in which event targeted marketing module 104 may utilize the information provided by merchant 102 at the time of enrollment of merchant 102.

Analyzing module 204 of targeted marketing module 104 may then perform the customer's analysis as requested by merchant 102. In one embodiment, the customer's analysis may include analyzing the historical transaction data of the customers that participated in transactions with merchant 102 in the past. In another embodiment, the customer analysis may also include analyzing the historical transaction data of the customers that may participate in transactions with merchant 102 in future. Targeted marketing module 104 may determine the customers that may participate in transactions with merchant 102 in the future, based on one or more factors. The one or more factors may include geographical location of the merchant 102 and the customers, business type of merchant 102, and/or transaction history of customers. For example, if a customer has moved from a particular location to merchant's 102 location, then it may be likely that the customer may participate in transactions with merchant 102 in the future. It should be apparent to a person who is ordinarily skilled in the art that the above example is just for the exemplary purposes and does not limit the scope of the disclosure in which targeting marketing module 104 may determine which customers may participate in transactions with merchant 102 in the future.

Further, the customer's analysis may also include comparing the historical transaction data of the customers that have participated in transactions with merchant 102 with historic transaction data of the same customers that have participated in transactions with competitors of merchant 102. The comparison of the historical transaction data may provide a holistic data of the customers that may participate in transactions with merchant 102.

Analyzing module 204 may obtain the historical transaction data of the customers from customer transaction database 106. Customer transaction database 106 may store customer's transaction history specific to each customer. The transaction history may include transaction value, transaction date, transaction time, transaction address, and/or frequency of transaction performed by customers. Customer transaction database 106 may have tagged or made clusters of the customers based on the transaction history of the customers. For example, if the merchant 102 is a retail chain, customers who spend with merchant 102 mainly on electronic items may be clustered in one group and customers who spend with another merchant mainly on food items may be clustered in a different group.

Analyzing module 204 may establish an aggregate data profile of the customers that have participated in transactions with merchant 102. In one embodiment, analyzing module 204 may establish an aggregate data profile of the customers that participated in transactions with merchant 102 and of the customers that may participate in transactions with merchant 102 in the future. In an embodiment, analyzing module 202 may establish the aggregate data profile of the customers based on the historical transaction data of the customers that have participated in transactions with the merchant 102 and/or of the customers that may participate in transactions with the merchant 102 in the future. Analyzing module 204 may have also compared the historical transaction data of the customers that have participated in transaction with merchant 102 with the historical transaction data of the same customers that have participated with the competitors of merchant 102 to establish the aggregate data profile of the customers.

Analyzing module 204 may also compare one or more characteristic data of the customers participating in transactions with merchant 102 to establish the aggregate data profile of the customers. Analyzing module 204 may obtain the one or more characteristics of the customers from the local database 108. The one or more characteristics may include age information, gender information, tenure information, martial status information, domicile information, family related information, social networking data, survey data, purchasing power information, size of wallet information, travel related information, hobby information, employer information, employment information, vocational information, education information, ethnicity information, government data, merchant rewards system data, third-party data, geographic information data, census bureau data, affinity group information and/or income information.

Selecting module 206 may select a targeted market campaign from a selection of available market campaigns to propose the targeted marketing campaign to merchant 102. In an embodiment, the selection of the targeted market campaign may depend partially on the aggregate data profile of the customers that participate in transactions with merchant 102. In an embodiment, the customers may include those customers that participate in transactions with merchant 102 and also the customers that may be selected by targeted marketing module 104 as probable customers that may participate with merchant 102 in the future.

Targeted marketing module 104 may obtain the targeted market campaign from marketing campaign databases 110. Marketing campaign database 110 may have a list of marketing campaigns based on the aggregate data profile of various customers. In one embodiment, marketing campaign database 110 is populated by third party service provider 112. Third party service provider 112 may include marketing agencies, advertising agencies, and/or campaign service providers. Third party service provider 112 may be adapted to design and perform online and offline marketing campaign or advertising campaign. In one embodiment, third party service provider 112 may have a business relationship with an operator of targeted marketing module 104. The business relationship may include a financial contract between the operator and/or third party service provider 112.

Targeted marketing module 104 may provide the aggregate data profile to third party service provider 112 based on which third party service provider 112 may design one or more marketing campaigns for merchant 102. Third party service provider 112 may populate the one or more marketing campaigns in marketing campaign database 110. In one embodiment, third party service provider 112 may also consider one or more factors other than the aggregate data profile while designing the targeted market campaign. The one or more factors may include cost or budget requirements, and/or time to implement the marketing campaign. In an embodiment, the one or more factors may be received from merchant 102. Further, other factors may also be considered while designing the targeted marketing campaign. The other factors may include the manner in which the marketing campaign needs to be implemented. For example, the marketing campaign may be implemented through direct mail, email, twitter, social networking portal, specific discount offer, cross-marketing offer, cross-promotional material, telemarketing offer, and/or the like.

Targeted marketing module 104 may propose the selected targeted marketing campaign to merchant 102. In an embodiment, targeted marketing module 104 may propose more than one targeted marketing campaign, to merchant 102 and provide an opportunity to merchant 102 to select any of the targeted marketing campaign that best suits the desires of merchant 102. Further, targeted marketing module 104 may also request merchant 102 accept an agreement. In one embodiment, merchant 102 may receive the targeted marketing campaign in response to accepting the agreement.

Targeted marketing module 104 may provide the aggregate data profile of the customers to merchant 102. Further, targeted marketing module 104 may provide an interface for merchant 102 to contact with one or more third party service provider 112 to receive a customized marketing campaign from third party service provider 112. In an embodiment, third party service provider 112 may have a business relationship with the operator of targeted marketing module 104. In another embodiment, targeted marketing module 104 may provide a portion of the aggregate data profile of the customers to the third party service provider 112 and may permit and/or facilitate third party service provider 112 in contacting merchant 102. In this embodiment, third party service provider 112 may contact merchant 102 through the interface provided by targeted marketing module 104. Third party service provider 112 may propose one or more suggestions to merchant 102 about the market campaigns. Merchant 102 may provide the aggregate data profile of the customers to third party service provider 112 and may also provide other factors to customize the marketing campaign such that the campaign may best suit the desires of merchant 102. The other factors may include the budget of the merchant for the market campaign, the time of implementation of the market campaign, the channels of delivering the market campaign and/or the manner of implementation of the market campaign. Third party service provider 112 may then design a customized market campaign for merchant 102 based on the aggregate data profile of the customers, the budget of the merchant 102 for the market campaign, the time of implementation of the market campaign, the manner of implementation of the market campaign and the like.

In an embodiment, the targeted marketing campaign may be implemented in one or more manners. The one or manners may include direct mail, email, twitter, social networking portal, specific discount offer, cross marketing offer, cross-promotional material, and/or telemarketing offer. Further, the targeted marketing campaign also includes matching contact information of the customers to provide the content of the campaign to only selected customers.

The implemented proposed marketing campaign may be tracked by tracking module 208. Tracking module 208 may analyze customer's response to the proposed marketing campaign. Specifically, tracking module 208 may track redemption of the proposed marketing campaign services. For example, if the marketing campaign involves providing discount to the customers on certain products, then tracking module 208 may track how many customers have participated in transactions with merchant 102 to redeem the provided discount.

In an embodiment, tracking module 208 may track the redemption after a predetermined time from the implementation of the marketing campaign. The predetermined time may be any duration of time such as a week, a month or the like.

Tracking module 208 may further track a quality of the proposed marketing campaign and may adjust the selection criteria of the targeted marketing campaign based on the quality of the implemented marketing campaign. In an embodiment, tracking module 208 may periodically adjust the selection criteria of the targeted marketing campaign based on the quality of the implemented marketing campaign.

Targeted marketing module 104 may act as a tool for providing efficient marketing campaigns to merchant 102, at least partially based on the desires of the merchant 102. Specifically, the marketing campaign provided by targeted marketing module 104 is based partially on actual historical transaction data of the customers and the others factors that may be received from the merchant 102. It may be apparent to a person ordinarily skilled in the art that targeting marketing module 104 may also conduct one or more surveys and may utilize the survey data along with the actual historical transaction data of the customers to select the targeted marketing campaign. In various embodiments, targeted marketing module 104 may be efficiently utilized by merchants, belonging to any category (small, medium, or large), to increase their business.

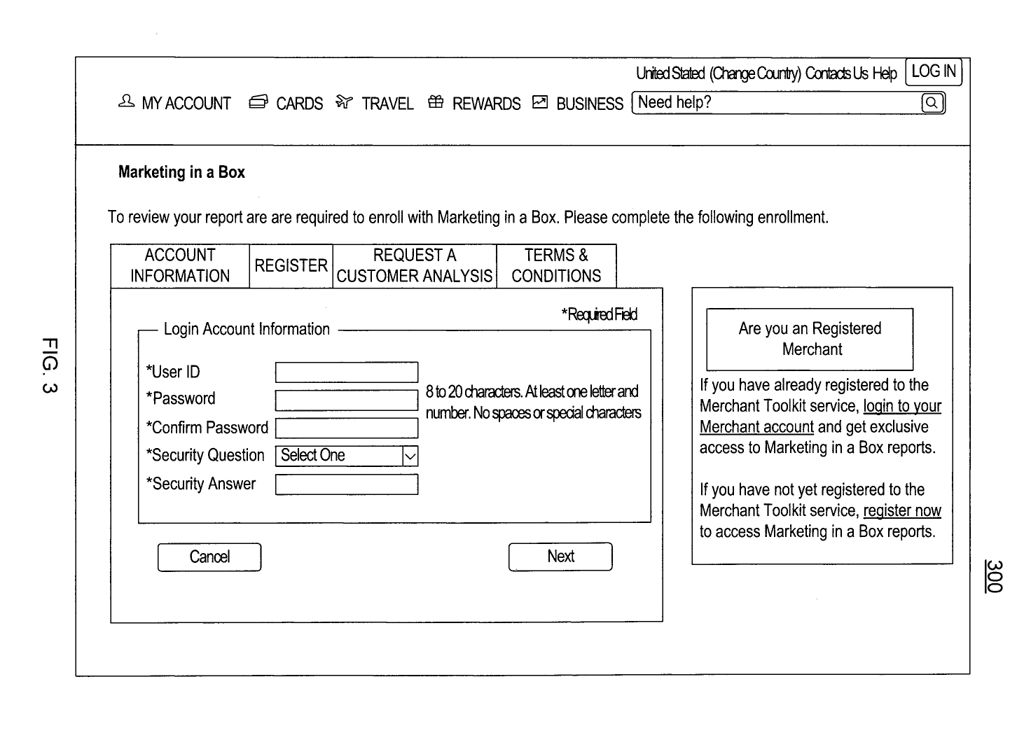

FIG. 3 is an account information page 300 of the online interface of targeted marketing module 104, according to an embodiment. In an embodiment, targeted marketing module 104 may receive a request from merchant 102 to perform a customer analysis. The request may also include providing a targeted marketing campaign to merchant 102 based on customer's analysis of merchant 102.

However, if merchant 102 is not an already enrolled member of targeted marketing module 104, then merchant 102 may create an account to receive customer analysis from targeted marketing module 104. Account information page 300 of FIG. 3 represents an exemplary login account information page, where merchant 102 may provide information to generate a login ID and password to access targeted marketing module 104.

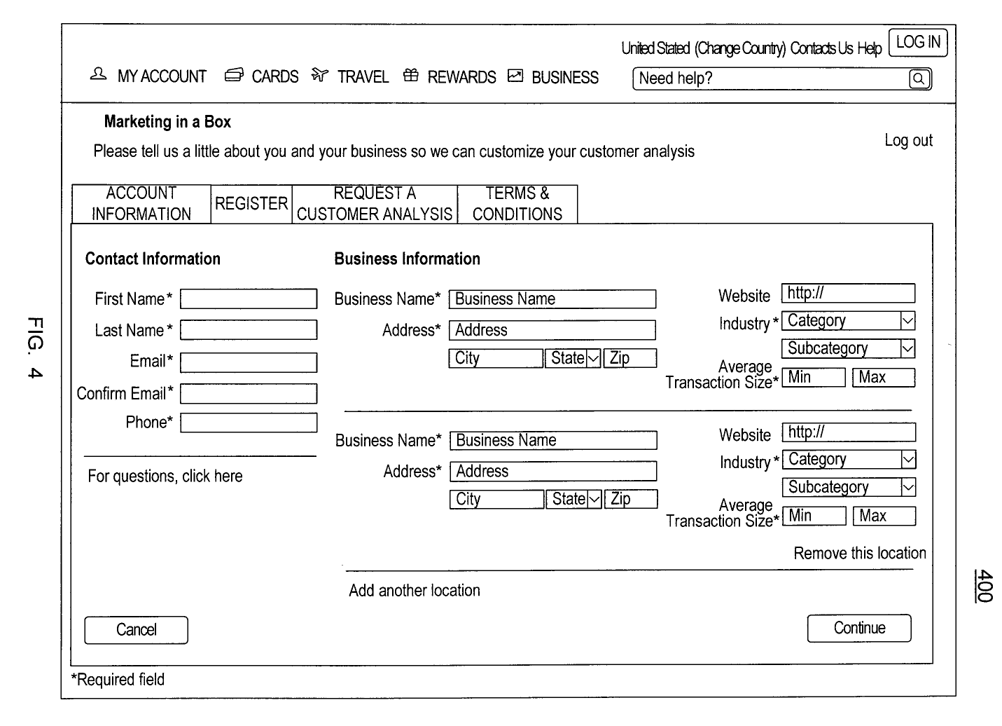

FIG. 4 depicts an exemplary enrollment/registration page 400 of the online interface of targeted marketing module 104, according to an embodiment. Merchant 102 may provide information such as contact information, business information, and/or the like to enroll with targeted marketing module 104. Merchant 102 may provide information for all the businesses that merchant 102 may be running within the country or outside the country on the same page 400.

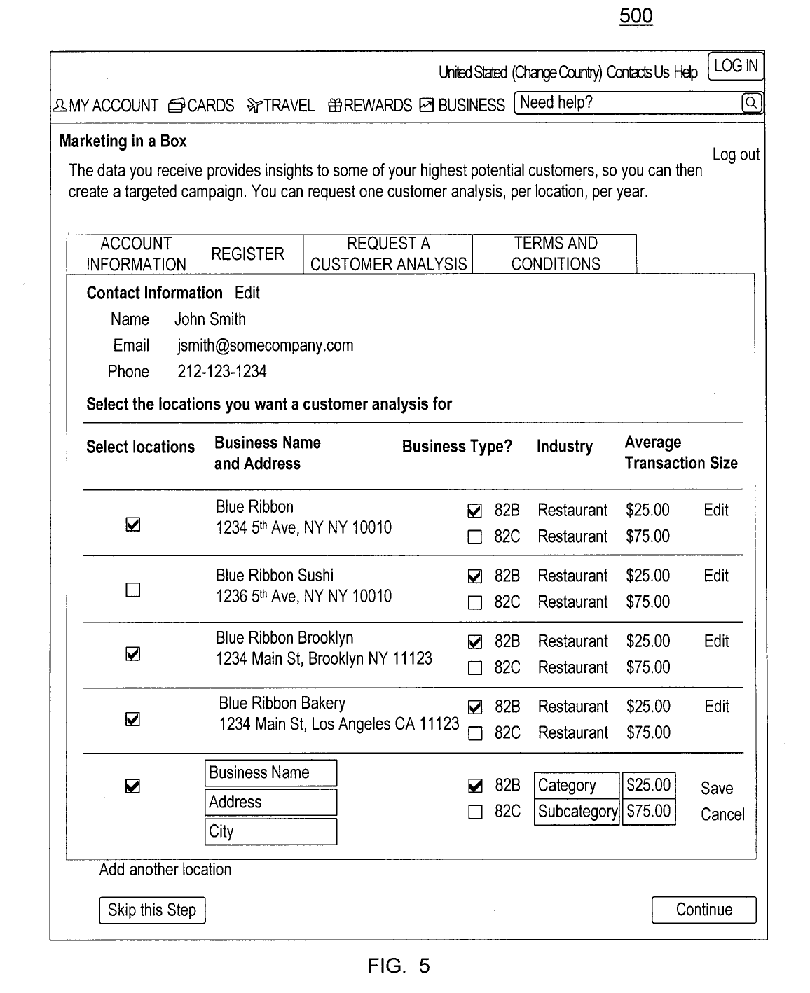

FIG. 5 depicts an exemplary request customer analysis page 500 of the online interface of targeted marketing module 104, according to an embodiment. Merchant 102 may request the customer analysis from targeted marketing module 104. In an embodiment, targeted marketing module 104 may further request merchant 102 to provide information to perform the customer's analysis. The information may include the business name and addresses, business type, industry, and/or average transaction size. In an embodiment, targeted marketing module 104 may provide an interface to merchant 102 to select the location, input business name, addresses and industry type, select business type, average transaction type and the like. In an embodiment, merchant 102 may select to skip the step of providing the above mentioned information, in which event targeted marketing module 104 may utilize the information provided by merchant 102 at the time of enrollment of merchant 102.

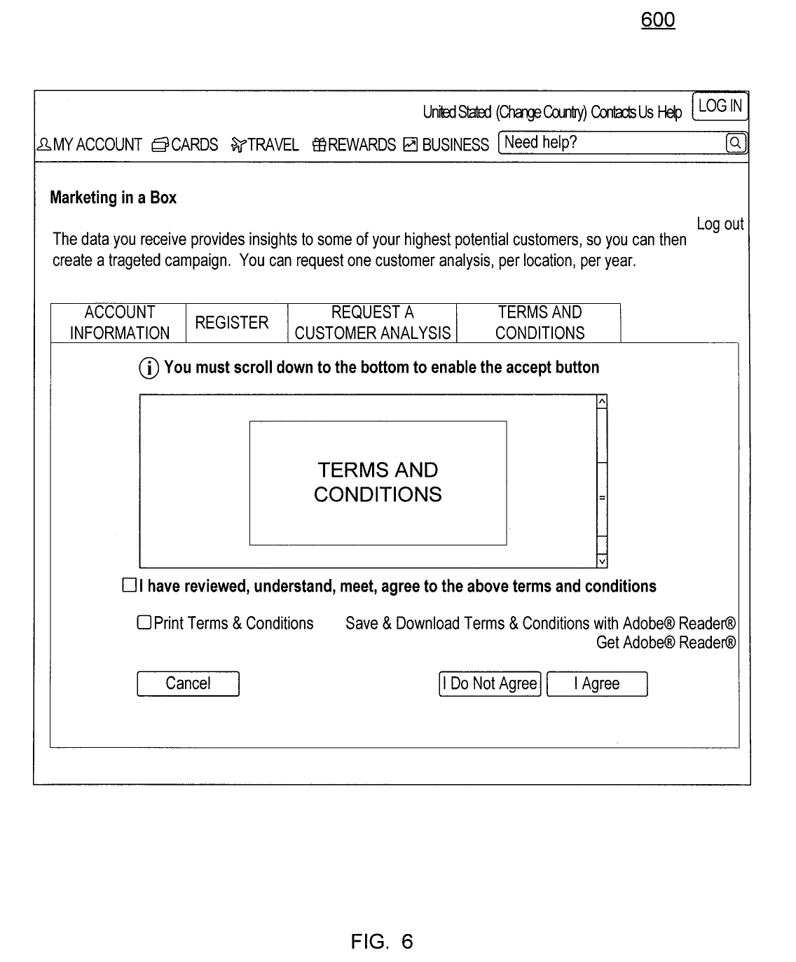

FIG. 6 depicts a terms and conditions page 600 of the online interface of targeted marketing module 104, according to an embodiment. The targeted marketing campaign may be selected for and/or by merchant 102. Targeted marketing module 104 may also request merchant 102 accept an agreement. In one embodiment, merchant 102 may receive the targeted marketing campaign in response to accepting the agreement.

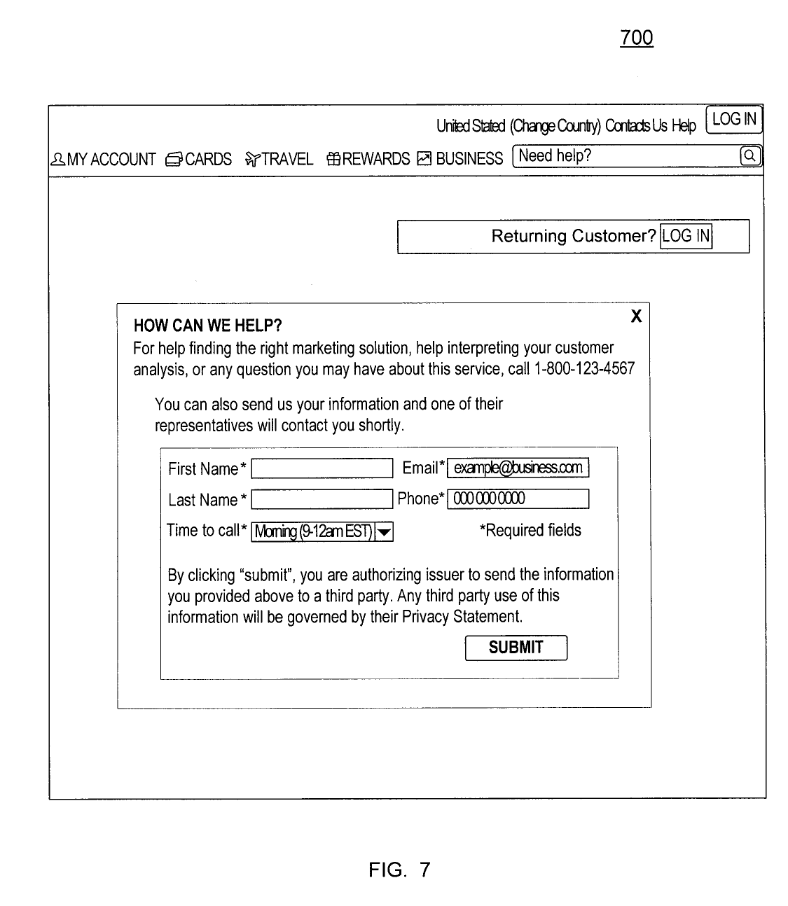

FIG. 7 depicts an exemplary interaction page 700 between third party service provider 112 and merchant 102, according to an embodiment. Third party service provider 112 may include marketing agencies, advertising agencies, and/or campaign service providers. Third party service provider 112 may be adapted to design and perform online and offline marketing campaign or advertising campaign. In one embodiment, third party service provider 112 may have a business relationship with an operator of targeted marketing module 104. The business relationship may include a financial contract between the operator and/or third party service provider 112.

In an embodiment, targeted marketing module 104 may provide the aggregate data profile to third party service provider 112 based on which third party service provider 112 may contact merchant 102 and propose merchant 102 about the marketing campaign services. In other embodiments, targeted marketing module 104 may provide the aggregate data profile of the customers to merchant 102 and merchant 102 may contact third party service provider 112 through the same interface.

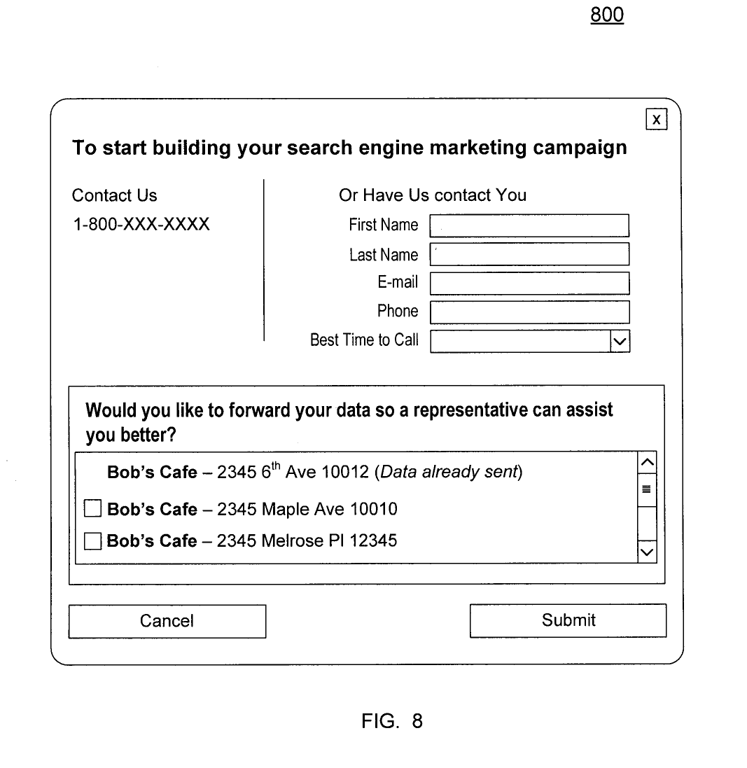

FIG. 8 depicts another exemplary interaction page 800 between third party service provider 112 and merchant 102, according to an embodiment. In an embodiment, targeted marketing module 104 may provide a portion of the aggregate data profile of the customers to the third party service provider 112 and may allow and or facilitate third party service provider 112 in contacting merchant 102. In this embodiment, third party service provider 112 may contact merchant 102 through the interface provided by targeted marketing module 104. Third party service provider 112 may propose one or more suggestions to merchant 102 about the market campaigns. Merchant 102 may provide the aggregate data profile of the customers to third party service provider 112 and may also provide other factors to customize the marketing campaign that may best suit the desires of merchant 102. The other factors may include the budget of the merchant 102 for the market campaign, the time of implementation of the market campaign, and/or the manner of implementation of the market campaign. Third party service provider 112 may then design a customized market campaign for merchant 102 based on the aggregate data profile of the customers, the budget of the merchant 102 for the market campaign, the time of implementation of the market campaign, the manner of implementation of the market campaign and the like. In an embodiment, targeted marketing campaign may be implemented in one or more manners. The one or manners may include direct mail, email, twitter, social networking portal, specific discount offer, cross marketing offer, cross-promotional material, and/or telemarketing offer.

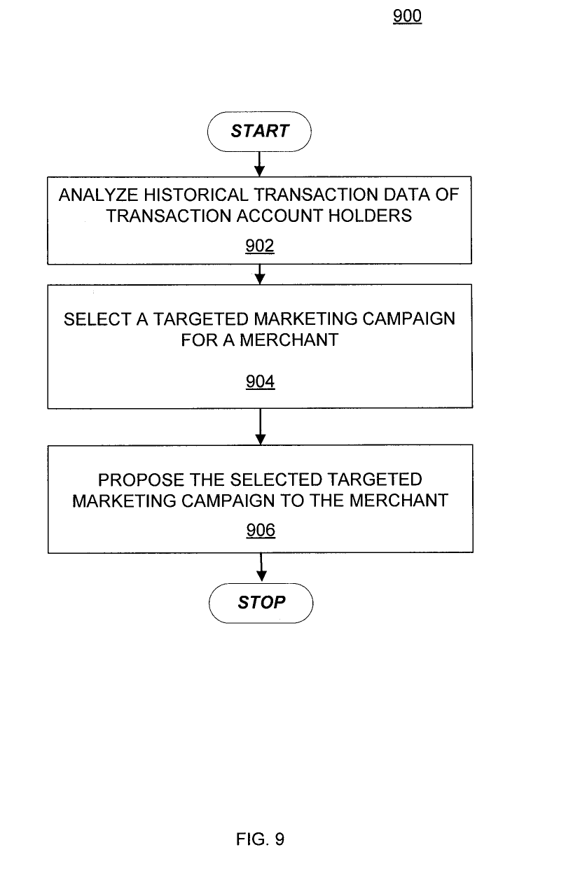

FIG. 9 depicts an exemplary flowchart illustrating an example process 900 for providing targeted marketing campaign to the first entity 102 (herein after interchangeably referred to as merchant 102), according to an embodiment.

Targeted marketing module 104 may be configured to communicate with customer transaction database 106, local database 108, marketing campaign databases 110, and third party service provider 112 through communication network 114. In an embodiment, targeted marketing module 104 may be an online interface that may be offered to merchant 102 to find specific information about the merchant's 102 business. The information may include transactional information of the customers who are participating in transactions with merchant 102, transactional information of the customers who are participating in transactions with competitors of merchant 102 and/or the like.

Targeted marketing module 104 may receive a request from merchant 102 to perform a customer analysis. The request may also include providing a targeted marketing campaign to merchant 102 based on the customer's analysis. Targeted marketing module 104 may request merchant 102 to enroll/register with targeted marketing module 104. In one embodiment, in response to enrolling/registering the target marketing module may send the request for customer's analysis.

In an embodiment, targeted marketing module 104 may perform the customer's analysis as requested by merchant 102 to establish an aggregate data profile of the customers (step 902). In one embodiment, the customer's analysis may include analyzing the historical transaction data of the customers that participated in transactions with merchant 102 in the past. In another embodiment, the customer analysis may also include analyzing the historical transaction data of the customers that may participate in transactions with merchant 102 in future. Targeted marketing module 104 may determine the customers that may participate in transactions with merchant 102 in the future, based on one or more factors. Further, in an embodiment, the customer's analysis may also include comparing the historical transaction data of the customers that have participated in transactions with merchant 102 with historic transaction data of the same customers that have participated in transactions with competitors of merchant 102. The comparison of the historical transaction data may provide a holistic data of the customers that may participate in transactions with merchant 102.

Analyzing module 204 may establish an aggregate data profile of the customers that participated in transactions with merchant 102 and of the customers that may participate in transactions with merchant 102 in the future. In an embodiment, analyzing module 202 may establish the aggregate data profile of the customers based on the historical transaction data of the customers that have participated in transactions with the merchant 102 and/or of the customers that may participate in transactions with the merchant 102 in the future.

Analyzing module 204 may also compare one or more characteristic data of the customers participating in transactions with merchant 102 to establish the aggregate data profile of the customers. Analyzing module 204 may obtain the one or more characteristics of the customers from the local database 108. The one or more characteristics may include age information, gender information, tenure information, martial status information, domicile information, family related information, social networking data, survey data, purchasing power information, size of wallet information, travel related information, hobby information, employer information, employment information, vocational information, education information, ethnicity information, government data, merchant rewards system data, third-party data, geographic information data, census bureau data, affinity group information, income information, and/or the like.

Selecting module 206 may select a targeted market campaign from a selection of available market campaigns to propose the targeted marketing campaign to merchant 102 (step 904). In an embodiment, the selection of the targeted market campaign may depend partially on the aggregate data profile of the customers that participate in transactions with merchant 102. In an embodiment, the customers may include those customers that participate in transactions with merchant 102 and also the customers that may be selected by targeted marketing module 104 as probable customers that may participate with merchant 102 in the future.

In an embodiment, targeted marketing module 104 may obtain the targeted market campaign from marketing campaign databases 110. Marketing campaign database 110 may have a list of marketing campaigns based on the aggregate data profile of various customers. In one embodiment, marketing campaign database 110 is populated by third party service provider 112. In one embodiment, third party service provider 112 may have a business relationship with an operator of targeted marketing module 104. The business relationship may include a financial contract between the operator and/or third party service provider 112.

In an embodiment, targeted marketing module 104 may provide the aggregate data profile to third party service provider 112 based on which third party service provider 112 may design one or more marketing campaigns for merchant 102. Third party service provider 112 may populate the one or more marketing campaigns in marketing campaign database 110. In one embodiment, third party service provider 112 may also consider one or more factors other than the aggregate data profile while designing the targeted market campaign. The one or more factors may include cost or budget requirements, time when the marketing campaign needs to be implemented and/or the like. In an embodiment, the one or more factors may be received from merchant 102. Further, other factors may also be considered while designing the targeted marketing campaign. The other factors may include the manner in which the marketing campaign is to be implemented. For example, the marketing campaign may be implemented through direct mail, email, twitter, social networking portal, specific discount offer, cross-marketing offer, cross-promotional material, and/or telemarketing offer.

Targeted marketing module 104 may propose the selected targeted marketing campaign to merchant 102 (step 906). Further, targeted marketing module 104 may also request merchant 102 accept an agreement. In one embodiment, in response to accepting the agreement merchant 102 may receive the targeted marketing campaign.

In other embodiments, targeted marketing module 104 may provide the aggregate data profile of the customers to merchant 102. Further, targeted marketing module 104 may provide an interface for merchant 102 to contact with various third party service provider 112 to receive a customized marketing campaign from third party service provider 112. In an embodiment, third party service provider 112 may have a business relationship with the operator of targeted marketing module 104. In another embodiment, targeted marketing module 104 may provide a portion of the aggregate data profile of the customers to the third party service provider 112 and may allow third party service provider 112 to contact merchant 102. In this embodiment, third party service provider 112 may contact merchant 102 through the interface provided by targeted marketing module 104. Third party service provider 112 may propose one or more suggestions to merchant 102 about the market campaigns. Merchant 102 may provide the aggregate data profile of the customers to third party service provider 112 and may also provide other factors to customize the marketing campaign that may best suit the desires of merchant 102. The other factors may include the budget of the merchant 102 for the market campaign, the time of implementation of the market campaign, and/or the manner of implementation of the market campaign. Third party service provider 112 may then design a customized market campaign for merchant 102 based on the aggregate data profile of the customers, the budget of the merchant 102 for the market campaign, the time of implementation of the market campaign, the manner of implementation of the market campaign and the like.

In an embodiment, targeted marketing campaign may be implemented in one or more manners. The one or manners may include direct mail, email, twitter, social networking portal, specific discount offer, cross marketing offer, cross-promotional material, and/or telemarketing offer. Further, the targeted marketing campaign also includes matching contact information of the customers to provide the content of the campaign to only to the selected customers.

Tracking module 208 may analyze customer's response to the implemented proposed marketing campaign. Specifically, tracking module 208 may track redemption of the proposed marketing campaign services. For example, if the marketing campaign involves providing discount to the customers on certain products, then tracking module 208 may track how many customers have participated in transactions with merchant 102 to redeem the provided discount.

In an embodiment, tracking module 208 may track the redemption after a predetermined time from the implementation of the marketing campaign. The predetermined time may be a week, a month or the like.

Tracking module 208 may further track a quality of the implemented proposed marketing campaign and may adjust the selection criteria of the targeted marketing campaign based on the quality of the implemented marketing campaign. In an embodiment, tracking module 208 may periodically adjust the selection criteria of the targeted marketing campaign based on the quality of the implemented marketing campaign.

While the steps outlined above represent a specific embodiment, practitioners will appreciate that there are any number of computing algorithms and user interfaces that may be applied to create similar results. The steps are presented for the sake of explanation only and are not intended to limit the scope of the disclosure in any way.

The present system and/or method (i.e., targeted marketing module 104, process 900, any part(s) or function(s) thereof) may be implemented using hardware, software or a combination thereof, and may be implemented in one or more computer systems or other processing systems. However, the manipulations performed were often referred to in terms, such as comparing or checking, which are commonly associated with mental operations performed by a human operator. No such capability of a human operator is necessary, or desirable in most cases, in any of the operations described herein, which form a part of the present system and/or method. Rather, the operations are machine operations. Useful machines for performing the operations in the present system and/or method may include general-purpose digital computers or similar devices.

In fact, in accordance with an embodiment, the present disclosure is directed towards one or more computer systems capable of carrying out the functionality described herein.

The computer system 1000 includes at least one processor, such as a processor 1002. Processor 1002 is connected to a communication infrastructure 1004, for example, a communications bus, a cross over bar, a network, and the like. Various software embodiments are described in terms of this exemplary computer system 1000. After reading this description, it will become apparent to a person skilled in the relevant art(s) how to implement the present disclosure using other computer systems and/or architectures.

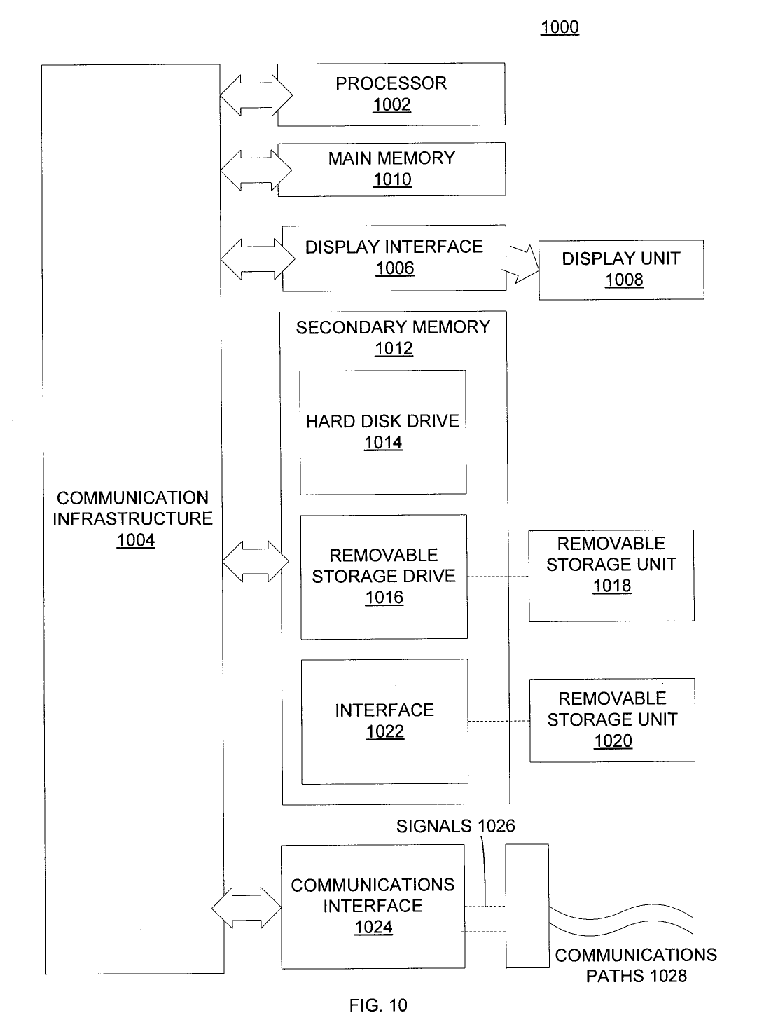

The computer system 1000 includes a display interface 1006 that forwards graphics, text, and other data from the communication infrastructure 1004 (or from a frame buffer which is not shown in FIG. 10) for display on a display unit 1008.

The computer system 1000 further includes a main memory 1010, such as random access memory (RAM), and may also include a secondary memory 1012. The secondary memory 1012 may further include, for example, a hard disk drive 1014 and/or a removable storage drive 1016, representing a floppy disk drive, a magnetic tape drive, an optical disk drive, etc. The removable storage drive 1016 reads from and/or writes to a removable storage unit 1018 in a well known manner. The removable storage unit 1018 may represent a floppy disk, magnetic tape or an optical disk, and may be read by and written to by the removable storage drive 1016. As will be appreciated, the removable storage unit 1018 includes a computer usable storage medium having stored therein, computer software and/or data.

In accordance with various embodiments, the secondary memory 1012 may include other similar devices for allowing computer programs or other instructions to be loaded into the computer system 1000. Such devices may include, for example, a removable storage unit 1020, and an interface 1022. Examples of such may include a program cartridge and cartridge interface (such as that found in video game devices), a removable memory chip (such as an erasable programmable read only memory (EPROM), or programmable read only memory (PROM)) and associated socket, and other removable storage units 1020 and interfaces 1022, which allow software and data to be transferred from the removable storage unit 1020 to the computer system 1000.

The computer system 1000 may further include a communication interface 1024. The communication interface 1024 allows software and data to be transferred between the computer system 1000 and external devices. Examples of the communication interface 1024 include, but may not be limited to a modem, a network interface (such as an Ethernet card), a communications port, a Personal Computer Memory Card International Association (PCMCIA) slot and card, and the like. Software and data transferred via the communication interface 1024 are in the form of a plurality of signals, hereinafter referred to as signals 1026, which may be electronic, electromagnetic, optical or other signals capable of being received by the communication interface 1024. The signals 1026 are provided to the communication interface 1024 via a communication path (e.g., channel) 1028. The communication path 1028 carries the signals 1026 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 1016, a hard disk installed in hard disk drive 1014, the signals 1026, and the like. These computer program products provide software to the computer system 1000. The present disclosure is directed to such computer program products.

Computer programs (also referred to as computer control logic) are stored in the main memory 1010 and/or the secondary memory 1012. Computer programs may also be received via the communication interface 1004. Such computer programs, when executed, enable the computer system 1000 to perform the features of the present disclosure, as discussed herein. In particular, the computer programs, when executed, enable the processor 1002 to perform the features of the present disclosure. Accordingly, such computer programs represent controllers of the computer system 1000.

In accordance with an embodiment, where the system and/or method is implemented using a software, the software may be stored in a computer program product and loaded into the computer system 1000 using the removable storage drive 1016, the hard disk drive 1014 or the communication interface 1024. The control logic (software), when executed by the processor 1002, causes the processor 1002 to perform the functions of the present system and/or method as described herein.

In another embodiment, the present system and/or method is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present system and/or method is implemented using a combination of both the hardware and the software.

While various embodiments of the present system and/or method have been described above, it should be understood that they have been presented by way of example, and not limitation. It will be apparent to persons skilled in the relevant art(s) that various changes in form and detail can be made therein without departing from the spirit and scope of the present system and/or method. Thus, the present system and/or method should not be limited by any of the above described exemplary embodiments, but should be defined only in accordance with the following claims and their equivalents.

In addition, it should be understood that the figures illustrated in the attachments, which highlight the functionality and advantages of the present system and/or method, are presented for example purposes only. The architecture of the present disclosure is sufficiently flexible and configurable, such that it may be utilized (and navigated) in ways other than that shown in the accompanying figures.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims. It should be understood that the detailed description and specific examples, indicating exemplary embodiments, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method comprising:
analyzing, by a computer based system configured to provide targeted marketing, historical transaction data to establish an aggregate data profile of transaction account holders which participated in transactions with a first entity;
selecting, by the computer based system and from a selection of available targeted marketing campaigns, a targeted marketing campaign to propose to the first entity based at least partially on the aggregate data profile of transaction account holders; and
proposing, by the computer based system, the selected targeted marketing campaign to the first entity.

2. The method of claim 1, wherein the aggregate data profile of the transaction account holders further comprise at least one of a comparison of transaction account holders participating in transactions with a second entity and transaction account holders participating in transactions with the first entity, and a holistic data comparison among of the transaction account holders participating in transactions with the first entity.

3. The method of claim 1, further comprising receiving, by the computer based system, available targeted marketing campaign information from campaign marketing providers.

4. The method of claim 1, wherein the aggregate data profile of transaction account holders further comprises comparisons of characteristic data among transaction account holders participating in transactions with the first entity, wherein the characteristic data comprises at least one of age information, gender information, tenure information, martial status information, domicile information, family related information, social networking data, survey data, purchasing power information, size of wallet information, travel related information, hobby information, employer information, employment information, vocational information, education information, ethnicity information, government data, merchant rewards system data, third-party data, geographic information data, census bureau data, affinity group information, and income information.

5. The method of claim 1, wherein selecting of the targeted marketing campaign is limited by a selection of a factor.

6. The method of claim 5, wherein the factor comprises at least one of cost and time.

7. The method of claim 1, wherein the targeted marketing campaign comprises at least one of direct mail, email, twitter, social networking portal, specific discount offer, cross-marketing offer, cross-promotional material, and telemarketing offer.

8. The method of claim 1, wherein the targeted marketing campaign is provided by a third party.

9. The method of claim 1, wherein the targeted marketing campaign is provided by a third party having a business relationship with the operator of the computer based system.

10. The method of claim 1, further comprising enrolling the first entity to use the system.

11. The method of claim 1, further comprising providing the targeted marketing campaign services to the first entity in response to receipt of agreement by the first entity.

12. The method of claim 11, further comprising tracking, by the computer based system, the redemption of targeted marketing campaign services by the transaction account holders.

13. The method of claim 11, further comprising tracking, by the computer based system, quality of the targeted marketing campaign services produced and periodically adjusting of the selection of available targeted marketing campaigns in response to the tracked quality.

14. The method of claim 1, wherein the aggregate data profile of transaction account holders which participated in transactions with the first entity is based at least partially on actual historical data.

15. The method of claim 1, wherein the first entity is a small business.

16. The method of claim 1, further comprising providing the aggregate data profile to the first entity.

17. The method of claim 1, wherein the targeted marketing campaign comprises matching contact information of the transaction account holders to targeted marketing campaign services.

18. The method of claim 17, wherein the transaction account holders comprise at least one of transaction account holders that have participated in transactions with a first entity and transaction account holders that are determined, by the computer based system, to be likely to participate in transactions with the first entity in the future.

19. A system comprising:
a tangible, non-transitory memory communicating with a processor configured to provide targeted marketing, the tangible, non-transitory memory having instructions stored thereon that, in response to execution by the processor, cause the processor to perform operations comprising:
analyzing, by the processor, historical transaction data to establish an aggregate data profile of transaction account holders which participated in transactions with a first entity;
selecting, by the processor and from a selection of available targeted marketing campaigns, a targeted marketing campaign to propose to the first entity based at least partially on the aggregate data profile of transaction account holders; and
proposing, by the processor, the selected targeted marketing campaign to the first entity.

20. An article of manufacture including a non-transitory, tangible computer readable medium having instructions stored thereon that, in response to execution by a computer-based system configured to provide targeted marketing, cause the computer-based system to perform operations comprising:
analyzing, by the computer based system, historical transaction data to establish an aggregate data profile of transaction account holders which participated in transactions with a first entity;
selecting, by the computer based system and from a selection of available targeted marketing campaigns, a targeted marketing campaign to propose to the first entity based at least partially on the aggregate data profile of transaction account holders; and proposing, by the computer based system, the selected targeted marketing campaign to the first entity.
